(19) United States
(12) Patent Application Publication
(10) Pub. No.: US 2012/0166005 A1
(43) Pub. Date: Jun. 28, 2012

(54) SHIFTING OF COMPUTATIONAL LOAD BASED ON POWER CRITERIA

(76) Inventor: David E. Mayhew, Northborough, MA (US)

(21) Appl. No.: 12/975,592

(22) Filed: Dec. 22, 2010

(51) Int. Cl. G06F 1/28; G01J 1/42; G06F 15/173

(52) U.S. Cl. 700/295; 709/226; 713/320; 250/208.2

(57) ABSTRACT

Computational load is shifted into or out of a computational array based on one or more metrics associated with power generation associated with power used by the computational array. The computational load is shifted by supplying data associated with the computational load into or away from the computational array. The one or more metrics include change in amount of available power for the computational array. The computational load is shifted from the computational array to a second computational array supplied with power from a different power generation facility, based on an indication of a reduction of the available power for the computational array and sufficient computational capacity of the second computational array.

### BACKGROUND

1. Field of the Invention

This application relates to shifting computational loads between computation centers based on power criteria.

2. Description of the Related Art

Computational arrays such as server farms are becoming more common as “cloud” computing, and other forms of remote computing, continue to expand. Remote computer facilities allow offsite functionality for various services such as mail, databases, and web hosting. Large organizations such as governments or corporations often utilize centralized or clusters of centralized computer facilities utilizing large numbers of servers. In addition, large groups of servers provide web services such as search and multi-media content. All these demands lead to an increase in the number of computational arrays of server computers.

Electricity constitutes one of the higher costs to operate computational arrays. Accordingly, substantial investment has been made in hardware and software to operate the servers of the computational arrays efficiently and save power where possible. For example, power savings techniques include matching resources available both on chip and in the computational array to load requirements and reducing power to those resources not needed. Thus, computational arrays are powered according to load requirements. As electricity has been shown to be a significant expense in operating large computational arrays, continued improvement in reducing energy utilization of computational arrays and/or associated cost is desirable.

### SUMMARY OF EMBODIMENTS OF THE INVENTION

One aspect of cost savings with respect to energy utilization by computational arrays is the ability to move computational load around based on the availability of energy utilized by the array. Thus, in an embodiment a method is provided that includes shifting computational load into or out of a computational array based on one or more metrics associated with power generation associated with power used by the computational array. The method may further include shifting the computational load by supplying data associated with the computational load into or away from the computational array. In an embodiment the one or more metrics include change in amount of available power for the computational array. In an embodiment the method further comprises shifting the computational load from the computational array to another computational array supplied with power from a different power generation facility, according to an indication of a reduction of the available power for the computational array.

In an embodiment the method further includes supplying power to the computational array from a fluctuating power generating facility; and shifting the computational load into and out of the computational array based on the indication of a status of the fluctuating power generating facility. In an embodiment, the fluctuating power generating facility is a solar array and solar intensity data is generated in concentric rings of photo-detectors around the solar array, from which the change in solar intensity is determined.

In another embodiment an apparatus includes a processing system responsive to indications of power generation conditions to determine an impending change in available power for a computational array based on the indications.

In an embodiment the apparatus further includes concentric rings of photo-detectors disposed around a solar array and coupled to the processing system, the processing system responsive to information from the photodetectors to detect a change in intensity of solar radiation available to the solar array so as to determine the impending change in available power.

In an embodiment the apparatus further includes optical imaging apparatus to measure size of blue sky, and distance and velocity of non-blue objects.

In another embodiment a system includes at least a first and a second computational array respectively receiving power from separate power generation facilities. A control system responds to one or more power metrics associated with power supplied to the first and the second computational arrays to shift computational load from the first to the second computational array based on the one or more metrics relating to available power.

In an embodiment the control system responds to shift the computational load from the first array to the second computational array based on an indication of a reduction of available power for the first computational array.

In an embodiment the apparatus includes optical communication paths coupling the first and second computational arrays.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a high level diagram of a computational system according to an embodiment of the invention.

FIG. 2 illustrates a high level flow diagram showing high level operations associated with transferring of computational load from the perspective of the computational array from which load needs to be transferred.

FIG. 3 illustrates a high level flow diagram showing high level operations associated with transferring of computational load from the perspective of the computational array to which load is transferred.

FIG. 4 illustrates an embodiment in which concentric rings of photodetectors are placed outside a solar array to detect upcoming changes in solar intensity available to the solar array.

FIG. 5 illustrates an embodiment in which cameras are used to detect upcoming changes in solar intensity for a solar array.

The use of the same reference symbols in different drawings indicates similar or identical items.

### DETAILED DESCRIPTION

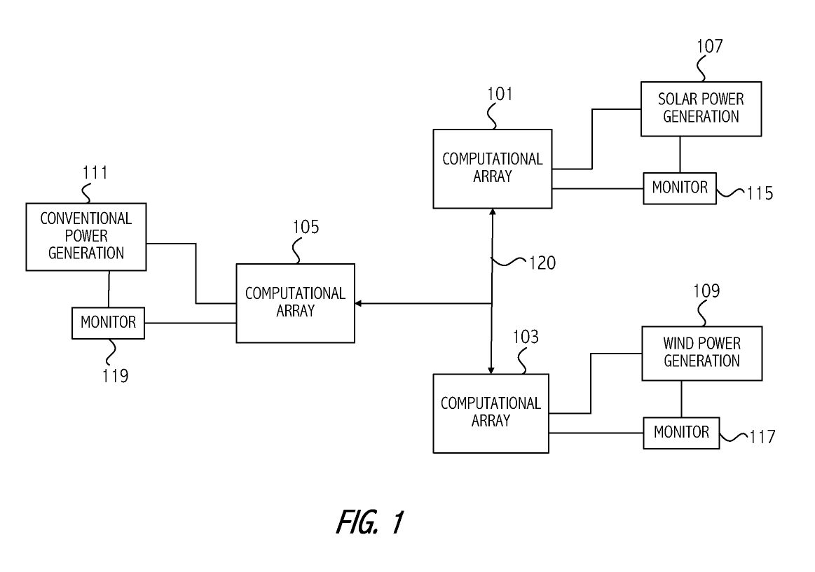

Referring to FIG. 1, illustrated is a high level block diagram of a system of computational arrays 101, 103, and 105. Each computational array 101, 103, and 105, is supplied with a power from an associated power generational facility 107, 109, 111. The power generational facilities 107, 109, 111 are typically independent of each other and may generate power from different sources. For example, power generation facility 107 may be a solar array. Power generation facility 109 may utilize wind energy and power generation facility 111 may be a conventional coal, gas, bio-mass, or nuclear power generation facility. Of course, any type of power generation may be utilized in the power generation facilities.

Volatile renewable energy sources (wind and solar) are relatively expensive because of their variable ability to produce power. In addition, connecting these power sources to the electrical grid frequently requires construction of new transmission lines. Construction of new transmission lines requires new towers between which fault prone aluminum cables are strung, and associated clearing of land for power breaks for the transmission towers. The cost of attaching renewable energy to the grid can exceed the cost of the windmills or solar panels being attached—necessitating very large renewable installations to amortize the cost of the tie-in to the electrical grid.

Instead of shipping power from generation facilities to distant computers and losing some percentage of the electrical power in the process through transmission loss, the computational arrays can be located where the power is generated, thereby substantially eliminating transmission loss resulting in cheaper electricity. Losses are approximately 10% in transmission and distribution, but an additional 30% is lost in the data center and another 5-10% of the power is lost in additional AC/DC conversion inefficiencies. These numbers ignore the cost of cooling, which typically runs between 25 and 33% of total power budget.

If computation is considered to be a local power sink, and the result of that computation is expressed as data (applied electricity) and that data is transmitted in optical fibers that functionally have zero (or comparatively reduced) loss, then computation can be used as a significantly more efficient applied electrical transmission and distribution model. That could require an over-build of computational capability, but the power advantages of local consumption and optical fiber data transmission and distribution in place of aluminum cable electrical transmission and distribution can more than cover the cost of idled computational resources. Further, all of these costs associated with power loss can be reduced by the functional conversion of renewable power generators into computer power supplies. With variable power generation for wind and solar based on weather and time of day, the computational load can be shifted to other computational facilities to take advantage of available power supplying a different computational array.

The advantages of utility computing are lower cost and higher efficiency. As used herein, utility computing is the conversion of computing from a user owned and managed computing infrastructure to a service provider owned and managed infrastructure. An electrical outlet represents an abstraction of a very complex and expensive infrastructure for generating, distributing, and regulating electricity. The goal of utility computing is the abstraction of computing to a similar “other managed” resource. For example, relatively few people generate their own electricity. Utility computing attaches the same logic to using a computer that already exists for owning a generator, that is, relatively few people will wholly perform their own computations. Rather, those computations are performed in computational facilities preferably powered by renewable energy with the marginal energy costs of additional computing being near zero until the compute resources are exhausted. Further, the environmental costs are less where compute load can be shifted (or maintained) in those facilities powered by renewable energy.

Further, data mobility is much greater than electrical mobility in the sense it is much easier to transport data than electricity. Many transmission lines are running at their limits. Shifting some of the load off of the electrical lines (even a small amount) and onto fiber optic data lines results in more available electrical transmission margin and greater overall electrical efficiency and lower environmental impact.

Further, the cost of electricity dominates computing costs. Projections are that 75% or more of future server costs will be power. A significant decrease in electrical cost would have an overwhelming impact on computational cost.

Referring again to FIG. 1, computational array 101 executes a computational load and receives power from fluctuating power generator 107 to execute that load. Power generator 107 is shown as a solar array in FIG. 1 but may instead be, e.g., a wind, tidal, or other similarly variable power generator whose power generation capability fluctuates based on external conditions such as solar intensity, wind, or tides. If the available power from power generator 107 is going to be reduced, because of, e.g., weather conditions or nightfall, the computational load can be shifted to another computational array. For example, computational array 101 can shift its computational load to computational array 103 via fiber optic communication lines 120. A power monitoring system 115 can monitor the conditions of power generator 107 and communicate with other power monitors 117 and 119 via the internet or other communications mechanism. The power monitoring systems may also communicate over the fiber optical communication lines 120. While shown as separate functions for ease of illustration, the power monitors 115, 117, and 119 may be part of the computational arrays with which they are associated. The power monitoring system 115 can determine characteristics of available power from the power monitoring stations 117 and 119 and request computational load transfer. The characteristics of available power supplied from power monitoring stations 117 and 119 may include such factors as power availability and price of the available power. In addition, the power monitoring systems 117 and 119 supply an indication of the spare computational capacity available, to indicate the ability to handle the computational load of computational array 101. The power monitor 115 evaluates the information received from the other power monitors and transfers the load based on the information received. The computational load may be split between computational facilities.

One of the criteria to be evaluated can be the cost of operating the computational array, which is typically related to the cost of electricity needed to both power the computational array and cool or heat the array). As the price of electricity can drop at times of off-peak demand, it may be advantageous to shift the computational load to the lowest cost facility (the computational array powered by the lowest cost power generation facility). Thus, one computational array facility may have higher energy costs as compared to another facility. In order to reduce the total computational cost, it is advantageous to shift the computational load to computational facilities able to obtain the lowest cost power.

As the price of electricity can drop after peak demand times, it may be advantageous to shift computational load to facilities based on time of day. For example, as lower costs become available because of time of day on the East Coast due to lower power demands compared to the West Coast, it may be advantageous to shift computational load from the West Coast to the East Coast and vice versa based on time of day and associated cost of electricity.

One of the criteria to determine transfer of computational load is the cost associated with the transfer of the computational load. The cost of transfer has to be less than the difference in the cost of power to make load transfer economically efficient.

In addition to cost of power, availability of power can also be a consideration. With alternative energy sources such as wind, solar, wave, etc., the availability of power from such sources may vary. Accordingly, the computational load for computational facilities being supplied with such power can be adjusted and/or shifted based on availability of such power. For example, cloudy days may cause computational load to be shifted to computational arrays supplied with power from a different power source. On the other hand, if abundant solar (or wave or wind) energy is available at a particular time, computational loads of other computational facilities supplied with conventional power may be shifted to the computational facility supplied with solar generated power. Such transfers may be particularly advantageous where subsidies are provided to solar (and other green) energy generation or taxes are imposed, at least indirectly, on computational arrays supplied with power generated with carbon based fuels.

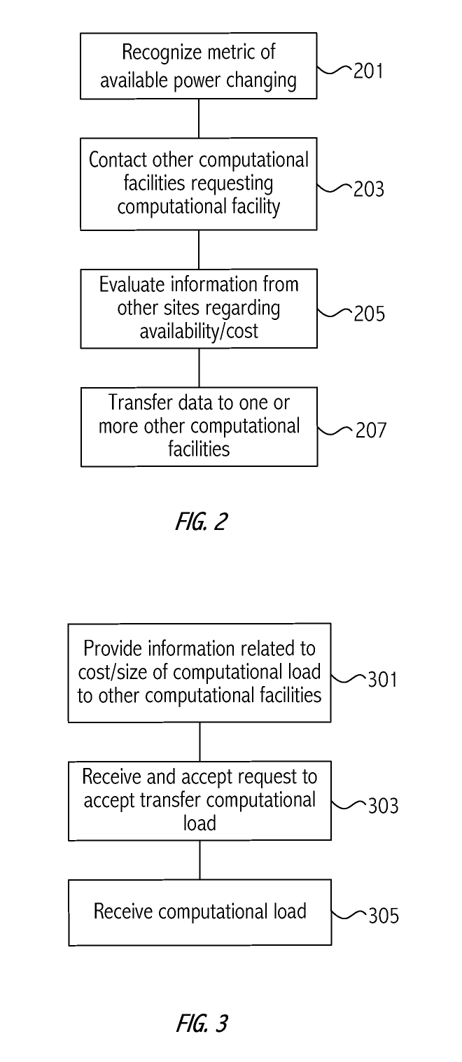

Referring to FIG. 2, illustrated is a high level flow diagram illustrating high level operations associated with transferring of computational load from the perspective of the computational array from which load needs to be transferred. At 201, the monitor associated with the computational array recognizes a metric of available power changing. That metric may be related to an amount of available power decreasing, e.g., wind decreasing on a wind-based power generation facility, or the cost of available electricity increasing. For example, the computational array normally powered from wind energy needs to switch to a more expensive fossil fuel based energy source. There may be a forecast for rain, or night may be approaching for a solar array. The computational array contacts other computational facilities requesting metrics associated with the computational facility. In one aspect, the contact may be in the form of a request for bid. Those metrics may include the amount of computational power available in, e.g., gigahertz hours, which is the amount of processing a single gigahertz processor can do in an hour, and the cost of each gigahertz hour, which may depend in part on the cost of the power being supplied to the array. Once all relevant information has been received from the computational arrays, the computational array transfers in 207 part or all of its computational load to one or more other computational arrays.

Rather than request information from other computational arrays (from their associated monitors), other computational arrays may push the information on a periodic basis so all the computational arrays know what alternatives are available on a real-time or close to real-time basis. In fact, a common computing facility may monitor all of the computational arrays and move computational load based on availability of handling computational load and the cost associated with handling the computational load.

FIG. 3 illustrates transfer of computational load from the perspective of a computational array receiving computational load. In 301, the computational array recognizes that it has availability in terms of computational load and provides that information to other computational facilities. That information may be pushed on a periodic basis regardless of availability. The receiving computational facility provides information related to cost and size of computational load it can handle. If another computational facility wishes to transfer its load, the transferring computational facility sends a request in 303 to the receiving computational facility, which can be accepted. If accepted, in 303 the computational load is transferred.

Load transfer will be dominated not by the transfer of active processes from one computational resource to another, but by the decision regarding where to start a new process. Load is transferred when a job is started in a second computational facility instead of a first computational facility.

Note that computational load can also be transferred based on a request from a power company. For example, a conventional utility may have an agreement and provide incentives in terms of cost of electricity to a computational array to transfer computational load to another computational facility during power shortages to help alleviate the shortage and provide more electrical generation and transmission capacity to other users.

Suppose that a solar energy installation supplies power directly to a computational array. Further suppose that the computational array has variable ancillary power capabilities and that the preferred mode for power management is to shift computational load into and out of the computational array based on power availability, but that there may also be some limited local power storage capability.

The available power at an array can reliably be determined based on the date and time, except for weather. An overcast day substantially reduces available power and a partly cloudy day can create significant amounts of power variability. A load shifting model functions much better in a predictive mode than in a reactive mode. Thus, an optical system that performs real-time cloud positioning and that provides accurate estimates of sun blockage time and duration can substantially increase the effectiveness of a solar powered computational model. Thus, in an embodiment, an optical imaging system tracks instantaneous solar intensity. Two general embodiments are described herein to track solar intensity, and of course variations of the described embodiments are possible.

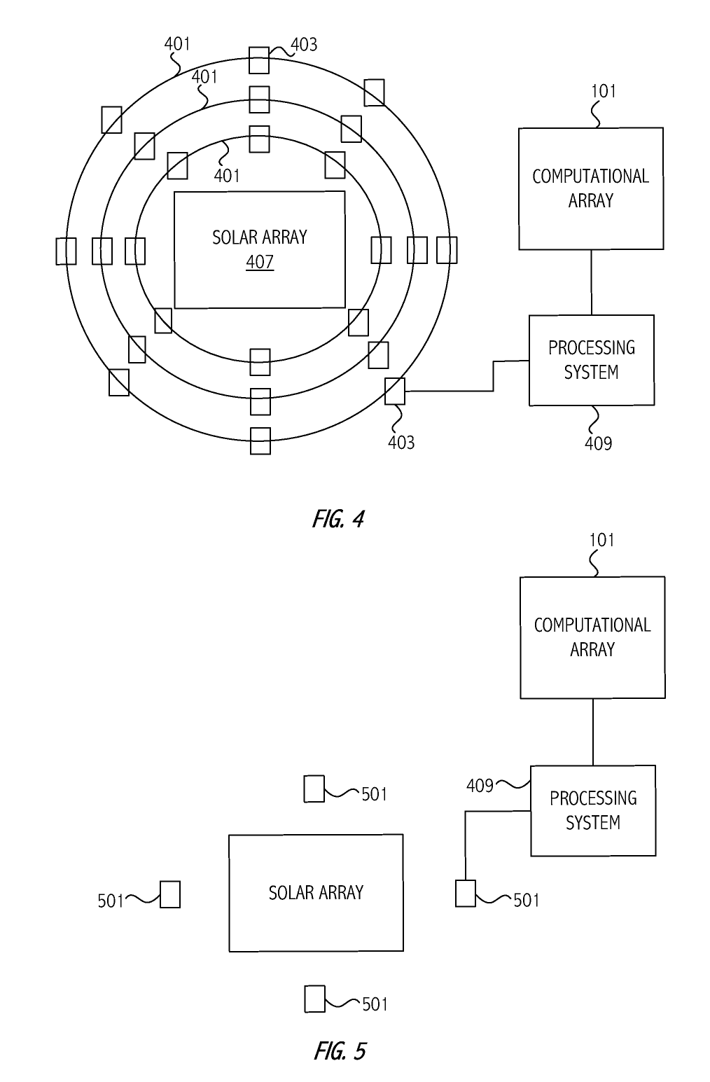

In one embodiment, referring to FIG. 4, concentric rings 401 of photodetectors 403 are placed outside a solar array 407 such that one or more of the photodetectors detect change in solar intensity, due, e.g., to clouds, and forwards the event to a centralized processing system 409 that uses the input from the entire array to determine the magnitude and duration of an event. While the processing system 409 is shown coupled to only one photodetector 403 for ease of illustration, the processing system 409 receives input from all of the photodetectors. Based on intensity information from each of the photodetectors, the processing system determines magnitude and direction of solar intensity impacting events, e.g., clouds moving over the array. Processing system 409, while shown separately for ease of illustration, may be incorporated into a collocated computational array. Further, the processing system 409 may be part of power monitor 115. The response characteristics of the associated solar array to changes in solar intensity help determine the diameter of the rings and the spacing of photodetectors.

Referring to FIG. 5, in a second embodiment, a set of optical image capture devices (cameras) 501 measure “blue sky” size and distance and velocity of non-blue objects. While the processing system 409 is shown coupled to only one photodetector camera 501 for ease of illustration, the processing system 409 receives input from all of the cameras 409. That allows the system to track size, distance, and velocity of clouds to determine magnitude of a solar intensity disruption. The number of cameras required depends on the needs of the particular system.

Based on the information available from the first or second embodiment, the centralized processing system uses the input to predict the magnitude and duration of an event that is about to impact the solar array. That prediction is used to transfer computational load to a different computational array. A solar power generating station can have highly transient power delivery due to clouds. The transient nature of solar power may necessitate the creation of a longer duty cycle energy storage network. For example, storage of power for very short periods of time using capacitors can address certain transient responses of a solar array to cloud conditions. While transferring active load in response to transient changes in power supply can be almost instantaneous, shifting of active load needs more careful management to ensure that computations of the active load resume appropriately at a new location.

As will be appreciated by those of skill in the art, other forms of “costs” (instead of, or in addition to, the cost of electricity and the associated costs of transport of electricity) can also be used to assess and dynamically allocate the computational resources. Such costs could include, for example, some metric associated with the environmental impact of the use of a computational resource (e.g., a metric used to assess greenhouse gas emissions), tax credits (e.g., the costs—which be positive or negative—of generating or consuming carbon tax credits which can be purchased or sold in a market for such financial instruments).

The description of the invention set forth herein is illustrative, and is not intended to limit the scope of the invention as set forth in the following claims. Other variations and modifications of the embodiments disclosed herein may be made based on the description set forth herein, without departing from the scope and spirit of the invention as set forth in the following claims.

1. A method comprising:
shifting computational load into or out of a computational array based on one or more metrics associated with power generation associated with power used by the computational array.

2. The method as recited in claim 1 wherein one of the one or more metrics is associated with cost of the power used by the computational array.

3. The method as recited in claim 1 further comprising shifting the computational load by supplying data associated with the computational load into or away from the computational array.

4. The method as recited in claim 1 wherein the one or more metrics include change in an amount of available power for the computational array.

5. The method as recited in claim 1 further comprising shifting the computational load from the computational array to another computational array supplied with power from a different power generation facility, according to one of the metrics providing an indication of a reduction of the available power for the computational array.

6. The method as recited in claim 1 further comprising shifting the computational load from the computational array to another computational array supplied with power from a different power generation facility according to an indication of available computational resources at the other computational facility.

7. The method as recited in claim 1 further comprising:
supplying the power to the computational array from a fluctuating power generating facility; and
shifting the computational load into or out of the computational array based on a status of the fluctuating power generating facility.

8. The method as recited in claim 7 further comprising:
tracking solar intensity for the fluctuating power generating facility that includes a solar array; and
providing as one of the metrics an indication related to the solar intensity as the status.

9. The method as recited in claim 8 further comprising:
generating solar intensity data in concentric rings of photo-detectors around the solar array; and
determining a change in solar intensity from the solar intensity data as the indication related to the solar intensity.

10. The method as recited in claim 9 further comprising determining magnitude and duration of the change in solar intensity.

11. The method as recited in claim 8 further comprising detecting solar intensity changes using optical imaging to measure size, distance and velocity of objects.

12. The method as recited in claim 7 further comprising:
supplying as the power, wind generated power to the computational array from the fluctuating power generating facility; and
utilizing a change in wind for the fluctuating power generating facility as the status.

13. The method as recited in claim 1 wherein the computational array includes a plurality of servers providing remote computing services.

14. The method as recited in claim 1 wherein a power generating facility supplying the power is collocated with the computational array.

15. An apparatus comprising:
a processing system responsive to indications of power generation conditions to determine an impending change in available power for a computational array based on the indications.

16. The apparatus as recited in claim 15 further comprising:
concentric rings of photodetectors disposed around a solar array and coupled to the processing system, the processing system responsive to information from the photodetectors to detect a change in intensity of solar radiation available to the solar array so as to determine the impending change in available power.

17. The apparatus as recited in claim 15 further comprising:
optical imaging apparatus to measure size of blue sky, and distance and velocity of non-blue objects.

18. A system comprising:
at least a first and a second computational array respectively receiving power from separate power generation facilities; and
a control system responsive to one or more metrics associated with of power supplied to at least one of the first and the second computational arrays, to shift computational load from the first to the second computational array based on the one or more metrics.

19. The system as recited in claim 18 wherein the one or more metrics include at least available power.

20. The system as recited in claim 18 wherein the control system is responsive to shift the computational load from the first computational array to the second computational array according to an indication of a reduction of available power for the first computational array.

21. The system as recited in claim 18 further comprising shifting the computational load from the first computational array to the second computational array supplied with power from a different power generation facility according to an indication of computational resources being available at the second computational array.

22. The system as recited in claim 18 further comprising optical communication paths coupling the first and second computational arrays.

23. A system comprising:
at least a first and a second computational array respectively receiving power from separate power generation facilities; and
a control system responsive to computational costs associated with at least one of the first and the second computational arrays to shift computational load from the first to the second computational array based on the computational costs.
